(19) United States
(12) Patent Application Publication
(10) Pub. No.: US 2013/0003578 A1
(43) Pub. Date: Jan. 3, 2013

(54) User Equipment Restricted Measurements For Multimedia Broadcast Single Frequency Network Networks

(76) Inventors: Teck Hu, Melbourne, FL (US); Chandrika K. Worrall, Newbury (GB)

(21) Appl. No.: 13/539,442

(22) Filed: Jun. 30, 2012

Related U.S. Application Data
(60) Provisional application No. 61/503,946, filed on Jul. 1, 2011.

(51) Int. Cl. H04W 24/00

(52) U.S. Cl. 370/252

(57) ABSTRACT

An example apparatus includes a processor and an associated memory, in which the processor is configured to receive an indicator that indicates whether Multimedia Broadcast Single Frequency Network (MBSFN) subframes are configured for measurement restriction and perform measurements based on the indicator.

### FIELD OF INVENTION

The invention(s) relate to communication equipment and, more specifically but not exclusively, to equipment and methods for performing Radio Resource Management (RRM) measurements in wireless devices.

### DESCRIPTION OF THE RELATED ART

This section introduces aspects that may help facilitate a better understanding of the invention(s). Accordingly, the statements of this section are to be read in this light and are not to be understood as admissions about what is in the prior art or what is not in the prior art.

The Multimedia Broadcast Single Frequency Network (MBSFN) configuration information for neighbor cells that can be provided to User Equipment (UE) is very limited. More specifically, as a part of measurement configuration, the following MBSFN information may be available to the UE:
configuration of the serving cell;
configuration indicator for intra-frequency Evolved Universal Terrestrial Radio Access (E-UTRA) neighbor cells; and
configuration indicator for inter-frequency E-UTRA neighbor cells,

where from the configuration indicators (e.g., neighCellConfig), the UE may have information indicating:
00: Not all neighbor cells have the same MBSFN subframe allocation as the serving cell on this frequency;
10: The MBSFN subframe allocations of all neighbor cells are identical to or subsets of that in the serving cell on this frequency;
01: No MBSFN subframes are present in all neighbor cells.

### BRIEF DESCRIPTION OF THE DRAWINGS

Other aspects, features, and benefits of various embodiments of the invention will become more fully apparent, by way of example, from the following detailed description and the accompanying drawings, in which:

FIG. 1 shows the data path for bearer unicast messages in a network, such as a LTE network according to an example embodiment;

FIG. 2 is an illustration of the logical architecture of a network that supports a protocol such as an enhanced Multimedia Broadcast Multicast Service (eMBMS) protocol;

FIG. 3 is a signal flow diagram for the MBSFN-ABS indicator according to the principles of the invention;

FIGS. 4a and 4b are a high-level flowchart for an example embodiment of a methodology for utilizing the MBSFN-ABS indicator according to the principles of the invention;

FIG. 5 depicts a high-level block diagram of a computer suitable for use in performing functions described herein.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. To facilitate understanding, identical reference numbers have been utilized, where possible, to designate identical elements that are common to the figures.

### DETAILED DESCRIPTION

Various modifications of the described embodiments, as well as other embodiments of the invention, which are apparent to persons skilled in the art to which the invention pertains are deemed to lie within the principle and scope of the invention as expressed in the following claims.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling for ease of understanding, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. Other words used to describe the relationship between elements should be interpreted in a like fashion (e.g., “between” versus “directly between,” “adjacent” versus “directly adjacent,” etc.).

As described above, the UE may have information indicating
00: Not all neighbor cells have the same MBSFN subframe allocation as the serving cell on this frequency;
10: The MBSFN subframe allocations of all neighbor cells are identical to or subsets of that in the serving cell on this frequency;
01: No MBSFN subframes are present in all neighbor cells.

Only with the value “10” (or other such appropriate parameter value) does the UE know which subframes are used for MBSFN. In all other cases, the UE does not know which subframes are used for MBSFN in the neighbouring cell.

In particular, in the cases of value “00” and “01” (or other such appropriate parameter values indicating the MBSFN status described above), the UE does not know the subframe used for MBSFN. Hence, the UE behavior in MBSFN subframe is not known. However, in cases with the value “10”, it is possible for the UE to correctly identify the MBSFN subframes for intra-frequency neighboring cell measurements.

It may be the case that the UE is not aware of cell-specific information about the MBSFN configuration used in the neighbor cells. Therefore, if MBSFN subframes are configured in even one neighbor cell, according to the above, the UE assumes that MBSFN configuration is used in all neighbor cells, for example, based on the information in NeighCellConfig. As a consequence, when MBSFN is configured in any neighbor cell i and the restricted subframe in a measured cell j is one of these subframes, the UE may use only the first Orthogonal Frequency-Division Multiple Access (OFDMA) symbol (i.e., #0) in that restricted subframe for performing Radio Resource Management (RRM) measurements. Consequently, a UE will measure only on symbol #0 (assuming the measured cell has MBSFN configured) even though the neighbor cell is non-MBSFN and all the other Cell Reference Symbols (CRS) symbols are available.

The 3rd Generation Partnership Project (3GPP) Radio Access Network 4 (RAN4) requirements for Enhanced Inter-Cell Interference Coordination (eICIC) are specified under the assumption that non-MBSFN configuration is assumed by the UE in the measured cell when performing measurements in subframes indicated by a time domain resource restriction pattern either for the serving cell or neighbor cell measurements. This means all four (4) Orthogonal Frequency-Division Multiple Access (OFDMA) symbols (symbols #0, 4, 7 and 11) are assumed to be available to the UE for performing measurements in all the restricted subframes regardless whether MBSFN is configured or not in any of the neighbor cells.

As mentioned above, it may be the case that the UE is not aware of cell-specific information about the MBSFN configuration used in the neighbor cells. Therefore, if MBSFN subframes are configured even in one neighbor cell, according to the current art, the UE assumes that MBSFN configuration is used in all neighbor cells, e.g., based on the information in NeighCellConfig. As a consequence, when MBSFN is configured in any neighbor cell i and the restricted subframe in a measured cell j is one of these subframes, the UE may use only first Orthogonal Frequency-Division Multiple Access (OFDMA)symbol (#0) in that restricted subframe for performing RRM measurements. This UE behavior is not consistent with the assumption used for deriving the current RAN4 requirements.

The problem identified above can be solved by: a) ensuring that the aggressor evolved Node B (eNB) configures RRM measurements of neighbor cell(s) that are not configuring MBSFN, since this information is known at the serving eNB that configures the measurements, or b) mandating the UE to treat all measured cell as non-MBSFN.

However, these solutions have the following key drawbacks:

For solution (a): The network can not use MBSFN Almost Blank Subframe (ABS). For example, possible MBSFN subframes in Frequency Division Duplex (FDD) are 1,2,3,6,7 and 8. In these subframes, restricted subframes can not be configured based on solution (a) above since the aggressor cell, if using MBSFN, will configure it in one of these subframes. If the neighbor cell is also using MBSFN, then these subframes will not be usable for restricted measurements. This in effect means that MBSFN ABS can not be configured in the aggressor cell.

For solution (b): An aggressor eNB configures normal ABS and the macro UE would be measuring a neighbor cell that is using MBSFN. Solution (b) mandates that the macro UE treats the neighbor cell as non-MBSFN and measures on all symbols. As a result the UE may be measuring over symbols even though no Common Reference Signal (CRS) is located there. (Note: the UE doesn't need to be mandated to make this assumption, if it can manage to meet the accuracy requirements without such assumption, that would be allowed).

Accordingly, provided herein are embodiments that introduce an indicator (e.g., a single bit indicator) in the Radio Resource Controller (RRC) signaling for restricted pattern (e.g., 0=MBSFN Cell, 1=non-MBSFN Cell) to inform the UE if the measured cell is operating in MBSFN or non-MBSFN mode.

The advantages of such an approach include:
the Aggressor eNb being able to configure the restricted pattern even though the measured cell/subframe is using MBSFN. Hence, MBSFN Almost Blank Subframe (ABS) can still be configured. This is because the aggressor eNB can configure RRM measurements of neighbor cell(s) that are configuring MBSFN according to embodiment in accord with the principles of this invention; and
when the measured cell is using MBSFN, the indicator in accord with the principles of this invention will inform the UE that the measurements should be done only on the first symbol. This will avoid the problem of Solution (b) above that may result in the UE performing measurements over symbols (not symbol #0) that may not contain Common Reference Signal (CRS) since that solution treats all measured cells as non-MBSFN.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figures. The processes may correspond to methods, functions, procedures, subroutines, subprograms, etc.

As used herein, the term “wireless device” or “device” may be considered synonymous to, and may hereafter be occasionally referred to, as a client, user equipment, mobile station, mobile user, mobile, subscriber, user, remote station, access terminal, receiver, mobile unit, etc., and may describe a remote user of wireless resources in a wireless communication network.

Similarly, as used herein, the term “base station” may be considered synonymous to, and may hereafter be occasionally referred to, as a Node B, evolved Node B, eNodeB, base transceiver station (BTS), RNC, etc., and may describe a transceiver in communication with and providing wireless resources to mobiles in a wireless communication network which may span multiple technology generations. As discussed herein, base stations may have all functionality associated with conventional, well-known base stations in addition to the capability to perform the methods discussed herein.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, parameters, elements, symbols, characters, terms, numbers, or the like.

In the following description, illustrative embodiments will be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

A processor and a memory may operate together to run apparatus functionality. For example, the memory may store code segments regarding apparatus functions. The code segments may in-turn be executed by the processor. Further, the memory may store process variables and constants for use by the processor.

The 3^{rd} generation (3G) mobile telecommunications system is a set of standards for the current generation of wireless telecommunications services, including mobile video, voice, and Web access applications. The Long Term Evolution (LTE) project was initiated by the 3^{rd} Generation Partnership Project (3GPP) to address the next generation of 3G technology and architecture. LTE includes a number of improvements over the current generation of 3G systems including spectral flexibility, flexible wireless cell size and an all Internet protocol (IP) architecture. In particular, the IP architecture enables easy deployment of services such as video, voice, Web access, etc. The IP architecture also allows for simpler inter-working with other fixed and mobile networks.

In an LTE network, the IP architecture allows a wireless user equipment end-point (UE) to send and receive user packets through its designated public data network gateway (PDN-GW). The data path between the UE and the PDN-GW goes through an enhanced base station (eNodeB) and a server gateway (S-GW). When a UE data packet is received, the PDN-GW forwards the data packet to its intended destination. The PDN-GW also accepts packets on the behalf of the UE, and then forwards the arriving packets to the UE.

The logical connection between the UE and the PDN-GW is referred to as the Evolved Packet System (EPS) bearer (sometimes referred to herein as a “bearer”). Associated with each bearer are one or more traffic flow templates (TFT) and a quality of service (QoS) profile.

The TFT describe the criteria for whether a packet belongs to a bearer or not. The most commonly used TFT parameters are the IP addresses of the source and destination, the port numbers at the source and destinations, and the protocol type. Typically, all of these parameters are part of the header information of a packet.

A QoS profile governs how the packets of a bearer should be treated by the network. As a UE may have multiple concurrent sessions, each with different QoS needs, multiple bearers can be set up between a UE and the PDN-GW, each supporting a different QoS. Further, multiple sessions of the same QoS class can be mapped onto the same bearer.

When a UE is first attached to the network, a default bearer, with a prescribed QoS, may be set up between the UE and the PDN-GW. Other bearers, referred to as dedicated bearers, can be set up and torn down on an “as needed” basis.

Multicast applications are one important class of applications for LTE networks where traffic from a source may be sent to a selected plurality of UEs or to all UEs (in broadcast mode). Examples of multicast applications are conference calls, push-to-talk (PTT) group calls, and multiple end-point media distribution (e.g., video conferences).

Multicast applications can be supported through the use of multiple unicast logical connections, however, this is not efficient in terms of both processing at the source and network utilization. With unicast, the source has to send the same packet to each destination. This increases the need of processing power at the source. For example, the same packet may traverse the same link and appear multiple times at the same network nodes, consuming bandwidth, particularly for the access link between the source and the network.

Therefore, in order to support multicast applications, multicast routing protocols have been developed for activating the routers in IP networks. For example, a multicast routing protocol may allow a router to inform its neighbors of the multicast traffic that it is currently receiving; and the multicast traffic that it wants to receive.

The multicast routing protocol may also regulate the propagation of multicast traffic between routers in IP networks. One popular multicast routing protocol is Protocol Independent Multicast—Sparse Mode, RFC 4601 (PIM-SM). In general, PIM-SM is very efficient in bandwidth as a router (i) only forwards the traffic of a multicast group to a neighbor if the neighbor requests such traffic, and (ii) may request traffic from a multicast group from only one of its neighbors. PIM-SM also supports general multicast in that it allows any member of a multicast group to transmit (i.e., be a source), even concurrently. Another popular multicast routing protocol is Source Specific Multicast, RFC 4607 (SSM), where a multicast group has only a single source.

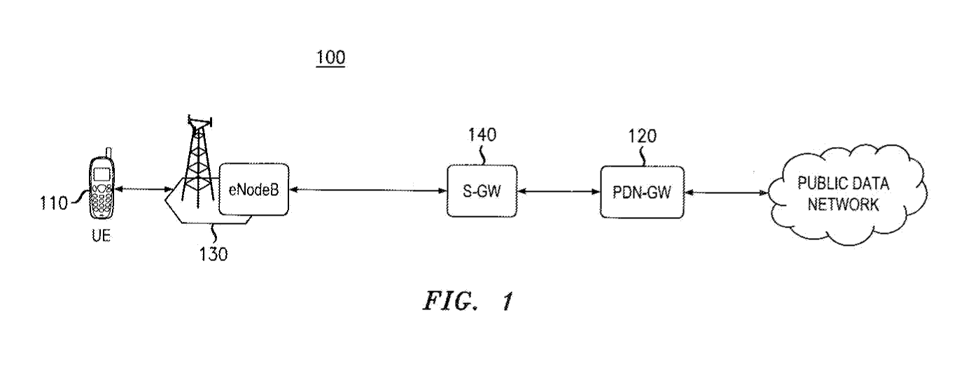

FIG. 1 shows the data path for bearer unicast messages in a network 100, such as a LTE network. In one embodiment, a user equipment end-point (UE) 110 comprising a wireless transceiver sends and receives data packets through its designated public data network gateway, PDN-GW 120. The data path between the UE 110 and the PDN-GW 120 goes through the eNodeB base station 130 and the server gateway, S-GW 140. When a data packet is received, the PDN-GW 120 then forwards the data packet to its intended destination in a public data network 150. The PDN-GW 120 may also accept data packets on the behalf of the UE 110, and then forward the arriving data packets to the UE 110.

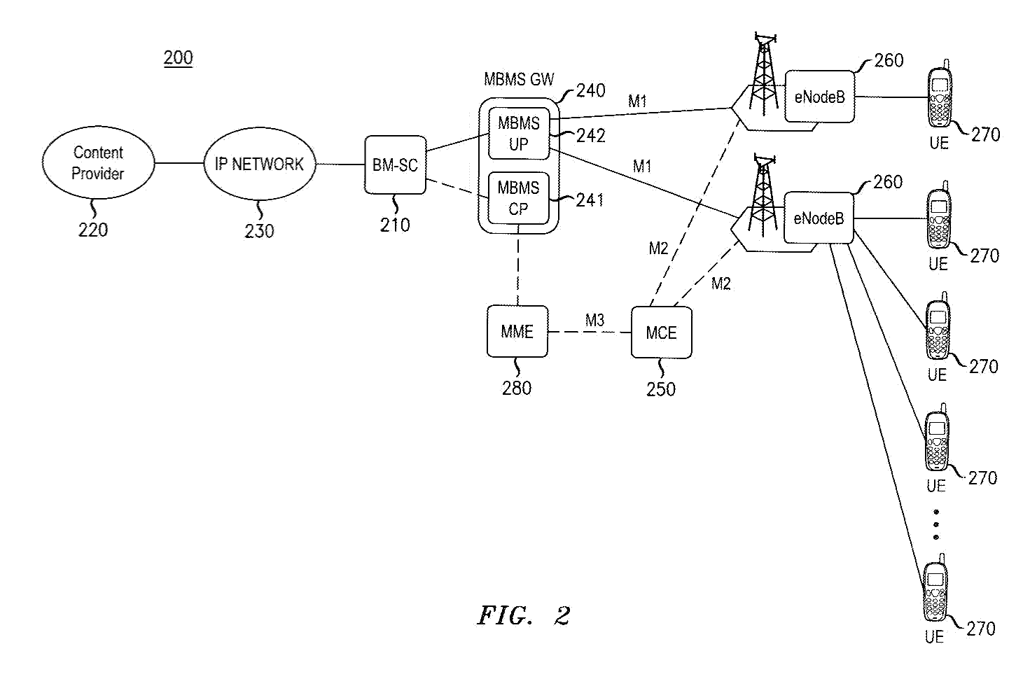

In another embodiment, an LTE network may support multicast/broadcast applications via the enhanced Multimedia Broadcast Multicast Service (eMBMS) protocol. FIG. 2 is an illustration of the logical architecture of a network that supports eMBMS.

A Broadcast Multicast Service Center (BM-SC) 210 is included for receiving IP multicast packets (originating at a content provider 220) from the IP network 230 by joining an appropriate IP multicast group. For example, when an IP multicast packet is received, the BM-SC 210 may provide announcements and scheduling of the eMBMS services and deliver the IP multicast packets to the LTE network.

Further, an MBMS gateway (MBMS GW) 240 may be connected to the BM-SC 210. In one embodiment, the MBMS GW 240 consists of two logical parts: a control part (MBMS CP) 241 which handles the session control signaling of the set up and release of the bearers that supports the IP multicast traffic; and a user part (MBMS UP) 242 that distributes the IP multicast traffic to a multi-cell coordination entity (MCE) 250 through a multi-cell management entity (MME) 280.

The MCE 250 may provide information to one or more eNodeB base stations 260 to setup, release, or modify a MBMS session. Although not shown, the MBMS GW 240 can be connected to a plurality of MCEs 250 in the same manner as depicted in FIG. 2. In addition, a plurality of UEs 270 may be connected to each of the eNodeB base stations 260.

In one embodiment, eMBMS multicast or broadcast transmissions may be implemented as multi-cell wireless transmissions by employing a synchronous frequency network mode of operation referred to as a Multimedia Broadcast Single Frequency Network (MBSFN). In an MBSFN, eMBMS data may be transmitted within a narrow frequency range almost simultaneously over the air from multiple, tightly synchronized cells over the same block of allocated transmission time. As a result, a UE 270 may receive multiple versions of the same transmission in an MBSFN, but with different delay. However, since the difference in delay is small, the UE 270 may treat the different transmissions as multi-path components of the same transmission. As such, a significant gain in spectral efficiency can be achieved in an MBSFN.

An area where all the eNodeB base stations 260 are synchronized for MBSFN may be referred to as an MBSFN synchronization area. In one embodiment, a UE 270 may roam from one eNodeB base station 260 to another eNodeB base station 260 within the same eMBMS synchronization area without service interruption. A group of cells within an eMBMS synchronization area that participate in an eMBMS transmission may be referred to as an eMBMS area. In various embodiments, an eMBMS area may support multiple instances of services, each with different sets of content for delivery to all the eNodeB base stations 260 within the area. As such, although eMBMS areas may be independent of each other, they may also overlap.

The eMBMS area also includes various interfaces M1, M2, and M3 between the components. For example, the M1 interface may be adapted for user traffic between the MBMS GW 240 and the one or more eNodeB base stations 260. In one embodiment, the M1 interface may include a SYNC protocol which ensures that a packet is transmitted by all the eNodeB base stations 260 within a synchronized area at about the same time. In another embodiment, the M2 and M3 interfaces are adapted for session control signaling between the MCE 250 and the one or more eNodeB base stations 260, and between the MME 280 and the MCE 250, respectively. In one embodiment, the MME 280 may be connected to a plurality of MCEs 250, just as the MCE 250 may be connected to a plurality of eNodeB base stations 260.

Radio resource management (RRM) is the system level control of co-channel interference and other radio transmission characteristics in wireless communication systems, for example cellular networks, wireless networks and broadcasting systems. RRM aims to utilize the limited radio spectrum resources and radio network infrastructure as efficiently as possible. Accordingly, RRM may involve strategies and algorithms for controlling communication parameters such as transmit power, channel allocation, data rates, handover criteria, modulation scheme, error coding scheme, etc.

RRM concerns multi-user and multi-cell network capacity issues, rather than point-to-point channel capacity. Traditional telecommunications research and education often dwell upon channel coding and source coding with a single user in mind, although it may not be possible to achieve the maximum channel capacity when several users and adjacent base stations share the same frequency channel. Efficient dynamic RRM schemes may increase the system capacity in an order of magnitude, which often is considerably more than what is possible by introducing advanced channel coding and source coding schemes. RRM is especially important in systems limited by co-channel interference rather than by noise, for example cellular systems and broadcast networks homogeneously covering large areas, and wireless networks consisting of many adjacent access points that may reuse the same channel frequencies.

The cost for deploying a wireless network is normally dominated by base station sites (real estate costs, planning, maintenance, distribution network, energy, etc.) and sometimes also by frequency license fees. Thus, radio resource management typically attempts to maximize the system spectral efficiency in bit/s/Hz/base station site or Erlang/MHz/site, under constraint that the grade of service should be above a certain level. The latter involves covering a certain area and avoiding outage due to co-channel interference, noise, attenuation caused by long distances, fading caused by shadowing and multipath, Doppler shift and other forms of distortion. The grade of service is also affected by blocking due to admission control, scheduling starvation or inability to guarantee quality of service that is requested by the users.

Static RRM involves manual as well as computer aided fixed cell planning or radio network planning. Dynamic RRM schemes adaptively adjust the radio network parameters to the traffic load, user positions, quality of service requirements, etc. Dynamic RRM schemes are considered in the design of wireless systems, in view to minimize expensive manual cell planning and achieve “tighter” frequency reuse patterns, resulting in improved system spectral efficiency.

RRM schemes may be centralized, where several base stations and access points are controlled by a Radio Network Controller (RNC). Others RRM schemes are distributed and implemented via autonomous algorithms in mobile stations, base stations or wireless access points, or coordinated by exchanging information among these stations. Examples of dynamic RRM schemes include: Power control algorithms, Link adaptation algorithms, Dynamic Channel Allocation (DCA) or Dynamic Frequency Selection (DFS) algorithms (allowing “cell breathing”), Traffic adaptive handover criteria (allowing “cell breathing”), Re-use partitioning, Adaptive filtering (such as Single Antenna Interference Cancellation (SAIC)), Dynamic diversity schemes (such as Soft handover, Dynamic Single Frequency Networks (DSFN), and Phased array antenna (with beamforming, Multiple-input multiple-output communications (MIMO), and Space-time coding)), Admission control, Dynamic bandwidth allocation using resource reservation multiple access schemes or statistical multiplexing (for example, Spread spectrum and/or packet radio), Channel-dependent scheduling (for instance, Max-min fair scheduling, Proportionally fair scheduling, Maximum throughput scheduling, Dynamic packet assignment (DPA), and Packet and Resource Plan Scheduling (PARPS) schemes), Mobile ad-hoc networks using multihop communication, Cognitive radio, Green communication, QoE-aware RRM, and Femtocells.

Some networks, including 3GPP LTE networks, are designed for a frequency reuse of one. In such networks, neighbor cells use the same frequency. While these networks can be highly efficient in terms of spectrum, they required close coordination between cells to avoid excessive inter-cell interference. Overall system capacity is not range limited or noise limited, but interference limited as are most cellular system deployments. Inter-cell radio resource management coordinates resource allocation between different cell sites. Various means of Inter-cell Interference Coordination (ICIC) have already been defined. Other examples of inter-cell radio resource management include dynamic single frequency networks, coordinated scheduling, multi-site MIMO and multi-site beam forming.

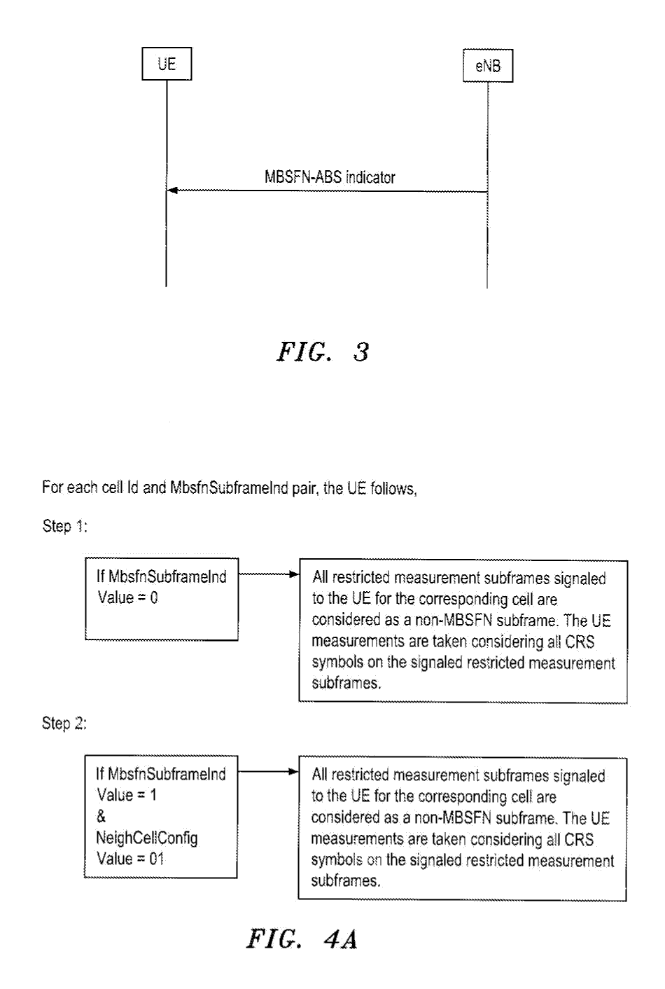

FIG. 3 is a signal flow diagram for the MBSFN-ABS indicator according to the principles of the invention. In one embodiment of the invention, dedicated RRC signaling is proposed to communicate the MBSFN-ABS indicator to the UE. For example, the signaling may be included as a new parameter within “MeasObjectEUTRA” IE. The IE MeasObjectEUTRA specifies information applicable for intra-frequency or inter-frequency EUTRA neighbouring cells. The restricted measurement pattern for neighbouring cells are signaled to the UE in “measSubframePatternConfigNeigh-r10” together with a list of cells indicated by “measSubframeCellList-r10. measSubframePatternConfigNeigh is extended to indicate MBSFN-ABS indicator. Each cell in the list has a corresponding “MBSFN-ABS indication” where one bit is used to signal the use of MBSFN subframe for measurement restriction. If the value of MBSFN- ABS indicator is 0, no MBSFN subframes are allocated as a restricted measurement subframe for the corresponding cell. If the value of MBSFN-ABS indicator is set to 1, MBSFN subframes are configured as the restricted measurement subframe for the corresponding cell.

An example ASN.1 structure for MBSFN-ABS indicator is described below. The MBSFN-ABS indicator parameter is referred to as “MbsfnSubframeInd”

MeasSubframePatternConfigNeigh-r10::=CHOICE {

| | |
|---|---|
| release | NULL, |
| setup | SEQUENCE { |
| measSubframePatternNeigh-r10 | MeasSubframePattern-r10, |
| measSubframeCellList-r10 | MeasSubframeCellList-r10 OPTIONAL |
| mbsfnSubframeIndList-r10 | MbsfnSubframeIndList-r10 OPTIONAL -- |
| Need OP | |
| } | |
| } | |
| MbsfnSubframeIndList-r10 ::= SEQUENCE (SIZE (1..maxCellMeas)) OF | |
| MbsfnSubframelnd | |
| <MB sfmSubframeInd :: = ENUMERATED {0,1} | |

The mbsfnSubframeIndList field comprises a list of MbsfnSubframeInd values where each value corresponding to neighbouring cell signalled in the measSubframeCellList.

The MbsfnSubframeInd parameter indicates whether subframes are not configured for measurement restriction. In one embodiment, a value of ‘0’ for MbsfnSubframeInd indicates that MBSFN subframes are not configured for measurement restriction, while value of ‘1’ for MbsfnSubframeInd indicates that MBSFN subframes are configured for measurement restriction.

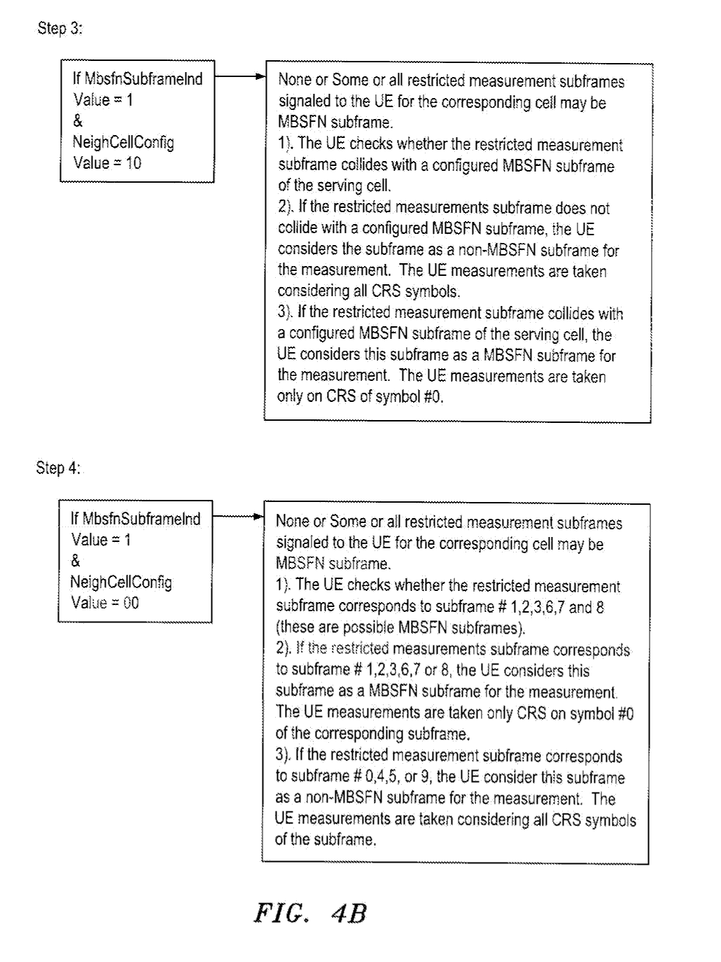

FIGS. 4a and 4b are a high-level flowchart for an example embodiment of a methodology for utilizing the MBSFN-ABS indicator according to the principles of the invention. The UE performs RRC measurements based on the MBSFN indicator.

For each cell Id and MbsfnSubframeInd pair, the UE follows the following procedure:

If MbsfnSubframeInd is set to false (or 0), the UE determines that it is to measure the subframe based on all CRS symbols regardless of the value of NeighCellConfig. In this instance, all restricted measurement subframes signaled to the UE for the corresponding cell are considered as a non-MBSFN subframe; the UE measurements are taken considering all CRS symbols on the signaled restricted measurement subframes. See Step 1 of FIG. 4a.

Thereafter, the UE will determine that MbsfnSubframeInd is set to true (or 1) and determine its action based on the value of the neighCellConfig parameter.

If neighCellConfig indicates a value of “01”, no MBSFN subframes are present in any neighboring cells. Hence, the UE measurement is based on CRS on all the symbols in a given ABS subframe. In this instance, all restricted measurement subframes signaled to the UE for the corresponding cell are considered as a non-MBSFN subframe and the UE determine that the measurements are to be taken considering all CRS symbols on the signaled restricted measurement subframes. See Step 2 of FIG. 4a.

If NeighCellConfig indicates value “10”, the MBSFN allocated to current cell and the neighboring cell is identical or neighboring cell MBSFN subframes are a subset of the current cell MBSFN subframes. If the MbsfnSubframeInd bit indicates that MBSFN ABS subframes are allocated as restricted measurement subframes, then the UE should perform the measurements considering use of MBSFN ABS measurements. If the UE known MBSFN subframe is allocated as ABS, then the UE should only measure CRS on symbol #0. Otherwise the measurement is performed on all the CRS symbols. (Note that depending on UE implementation, the UE may not be required to measure on all CRS symbols if the required performance requirements can be met with fewer CRS symbols.) Given that the current cell MBSFN subframes are known to the UE, the UE shall measure the corresponding neighboring cell subframe considering it as MBSFN subframe in the case that MbsfnSubframeInd is set to true (or 1).

In this instance, none or some or all restricted measurement subframes signaled to the UE for the corresponding cell may be MBSFN subframe. Therefore, the UE further determines whether the restricted measurement subframe collides with a configured MBSFN subframe of the serving cell. If the restricted measurements subframe does not collide with a configured MBSFN subframe, the UE considers the subframe as a non-MBSFN subframe for the measurement and UE measurements are taken considering all CRS symbols. If the restricted measurement subframe collides with a configured MBSFN subframe of the serving cell, the UE considers this subframe as a MBSFN subframe for the measurement and UE measurement is taken only on CRS of symbol #0. See step 3 of FIG. 4b.

If NeighCellConfig indicates value “00”, and MbsfnSubframeInd is set to true (or 1) for a given cell, the UE shall consider all the possible subframes (subframe #1,2,3,6,7 and 8) are MBSFN subframes and the measurement shall be performed only based on CRS symbol #0 on these subframes. In this instance, none or some or all restricted measurement subframes signaled to the UE for the corresponding cell may be MBSFN subframe. Therefore, the UE further checks whether the restricted measurement subframe corresponds to subframe #1,2,3,6,7 and 8 (these are possible MBSFN subframes). If the restricted measurements subframe corresponds to subframe #1,2,3,6,7 or 8, the UE considers this subframe as a MBSFN subframe for the measurement and takes UE measurements only CRS on symbol #0 of the corresponding subframe. Alternatively, if the restricted measurement subframe corresponds to subframe #0,4,5 or 9, the UE consider this subframe as a non-MBSFN subframe for the measurement and takes UE measurements considering all CRS symbols of the subframe. See step 4 of FIG. 4b.

The UE reads measSubframePatternNeigh, measSubframeCellList, and mbsfnSubframeIndList.

The UE reads NeighCellConfig. There is only one NeighCellConfig value corresponding to the given frequency.

There is a corresponding mbsfnSubframeIndList entry (MbsfnSubframeInd) for each cell Id given in measSubframeCellList.

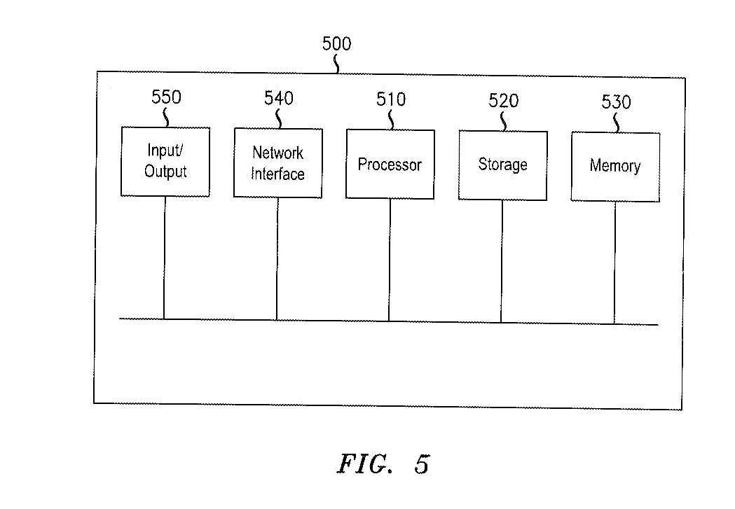

The above-described methods may be implemented on a computer using well-known computer processors, memory units, storage devices, computer software, and other components. A high-level block diagram of such a computer is illustrated in FIG. 5. Computer 500 contains a processor 510, which controls the overall operation of the computer 500 by executing computer program instructions which define such operation. The computer program instructions may be stored in a storage device 520 (e.g., magnetic disk) and loaded into memory 530 when execution of the computer program instructions is desired. Thus, the steps of the method of FIGS. 3, 4a and 4b may be defined by the computer program instructions stored in the memory 530 and/or storage 520 and controlled by the processor 510 executing the computer program instructions. The computer 500 may include one or more network interfaces 540 for communicating with other devices via a network for implementing the steps of the method. The computer 500 may also include other input/output devices 550 that enable user interaction with the computer 500 (e.g., display, keyboard, mouse, speakers, buttons, etc.). One skilled in the art will recognize that an implementation of an actual computer could contain other components as well, and that FIG. 5 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. An apparatus comprising:
a processor and an associated memory, the processor configured to:
receive an indicator that indicates whether Multimedia Broadcast Single Frequency Network (MBSFN) subframes are configured for measurement restriction;
perform measurements based on the indicator.

2. The apparatus of claim 1 wherein the processor is configured to receive the indicator with a “MeasObjectEUTRA” IE.

3. The apparatus of claim 1 wherein the processor is configured to receive the indicator for a first neighboring cell and a restricted measurement pattern for the first neighboring cell.

4. The apparatus of claim 1 wherein the processor is further configured to:
perform the measurements for a cell based on a cell identifier, the indicator being associated with a cell identifier so as to indicate whether MBSFN subframes are configured for measurement restriction for the cell.

5. The apparatus of claim 1 wherein the indicator comprises a list of values where each value corresponds to a neighboring cell and a respective indicator on the list indicates whether MBSFN subframes are configured for measurement restriction for a respective cell.

6. The apparatus of claim 1 wherein the apparatus is a wireless device or a user equipment device.

7. The apparatus of claim 1 wherein the measurements are radio resource control measurements for a first cell.

8. The apparatus of claim 1 wherein the indicator is included in the signaling for restricted pattern from an eNb.

9. The apparatus of claim 1 wherein the processor is configured to measure a subframe based on all Cell Reference Symbols (CRS) symbols when the indicator indicates that MBSFN subframes are not configured for measurement restriction.

10. The apparatus of claim 1 wherein, when the indicator indicates that MBSFN subframes are configured for measurement restriction and the processor determines that no MBSFN subframes are present in any neighboring cells, the processor is configured to measure a subframe based on all Cell Reference Symbols (CRS) symbols.

11. The apparatus of claim 1 wherein, when the indicator indicates that MBSFN subframes are configured for measurement restriction and the processor determines MBSFN subframe allocations of all neighbor cells are identical to or subsets of that in the serving cell and the processor determines a restricted measurements subframe does not collide with a configured MBSFN subframe, the processor is configured to measure the restricted measurements subframe based on all Cell Reference Symbols (CRS) symbols.

12. The apparatus of claim 1 wherein, when the indicator indicates that MBSFN subframes are configured for measurement restriction and the processor determines MBSFN subframe allocations of all neighbor cells are identical to or subsets of that in the serving cell and the processor determines a restricted measurements subframe does collide with a configured MBSFN subframe, the processor is configured to measure the restricted measurements subframe based only on Cell Reference Symbols (CRS) of symbol #0.

13. The apparatus of claim 1 wherein, when the indicator indicates that MBSFN subframes are configured for measurement restriction and the processor determines that not all neighbor cells have the same MBSFN subframe allocation as the serving cell and the processor determines the restricted measurements subframe corresponds to subframe #1,2,3,6,7 or 8, the processor is configured to measure the restricted measurements subframe based only on Cell Reference Symbols (CRS) of symbol #0 of the corresponding subframe #1,2,3,6,7 or 8.

14. The apparatus of claim 1 wherein, when the indicator indicates that MBSFN subframes are configured for measurement restriction and the processor determines that not all neighbor cells have the same MBSFN subframe allocation as the serving cell and the processor determines the restricted measurements subframe corresponds to subframe #0, 4, 5 or 9, the processor is configured to measure the restricted measurements subframe based all Cell Reference Symbols (CRS) of the corresponding subframe #0, 4, 5 or 9.

15. A method comprising:
receiving an indicator that indicates whether Multimedia Broadcast Single Frequency Network (MBSFN) subframes are configured for measurement restriction;
performing measurements based on the indicator.

16. The method of claim 15 wherein performing measurements comprises:
measure a subframe based on all Cell Reference Symbols (CRS) symbols when the indicator indicates that MBSFN subframes are not configured for measurement restriction.

17. The method of claim 15 wherein performing measurements comprises:
measuring a subframe based on all Cell Reference Symbols (CRS) symbols when the indicator indicates that MBSFN subframes are configured for measurement restriction and no MBSFN subframes are present in any neighboring cells.

18. The apparatus of claim 1 wherein performing measurements comprises:
measuring a restricted measurements subframe based on all Cell Reference Symbols (CRS) symbols when
the indicator indicates that MBSFN subframes are configured for measurement restriction, and
subframe allocations of all neighbor cells are identical to or subsets of that in the serving cell, and
the restricted measurements subframe does not collide with a configured MBSFN subframe.

19. The method of claim 15 wherein performing measurements comprises:
measuring a restricted measurements subframe based only on Cell Reference Symbols (CRS) of symbol #0 when
the indicator indicates that MBSFN subframes are configured for measurement restriction, and
MBSFN subframe allocations of all neighbor cells are identical to or subsets of that in the serving cell, and
the restricted measurements subframe does collide with a configured MBSFN subframe.

20. The method of claim 15 wherein performing measurements comprises:
measuring a restricted measurements subframe based only on Cell Reference Symbols (CRS) of symbol #0 of the corresponding subframe #1,2,3,6,7 or 8 when
the indicator indicates that MBSFN subframes are configured for measurement restriction,
not all neighbor cells have the same MBSFN subframe allocation as the serving cell, and
the restricted measurements subframe corresponds to subframe #1,2,3,6,7 or 8, the processor is configured to.

21. The method of claim 15 wherein performing measurements comprises:
measuring a restricted measurements subframe based all Cell Reference Symbols (CRS) of the corresponding subframe #0, 4, 5 or 9 when
the indicator indicates that MBSFN subframes are configured for measurement restriction, and
not all neighbor cells have the same MBSFN subframe allocation as the serving cell, and
the restricted measurements subframe corresponds to subframe #0, 4, 5 or 9.
